(19) United States
(12) Patent Application Publication
(10) Pub. No.: US 2012/0021696 A1
(43) Pub. Date: Jan. 26, 2012

(54) DATA CARD WITH USB FUNCTION

(75) Inventors: YAO-NAN CHANG, Tu-Cheng (TW); ZHI-FU GUO, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/889,431

(22) Filed: Sep. 24, 2010

(30) Foreign Application Priority Data
Jul. 20, 2010 (CN) 201010231735.7

(51) Int. Cl. H04B 1/38; G06K 19/073

(52) U.S. Cl. 455/73; 235/492

(57) ABSTRACT

A data card includes a main chip, a switch, and an input/output interface. The input/output interface receives a voltage signal and a control signal, and transmits the voltage signal and the control signal to the switch. When the control signal is a first control signal, the switch switches on, and the voltage signal is transmitted to the main chip via the switch, causing the main chip to enable a universal serial bus (USB) function of the data card. When the control signal is a second signal, the switch switches off, and no voltage signal is supplied to the main chip, causing the main chip to disable the USB function.

### BACKGROUND

1. Technical Field

Embodiments of the present disclosure relate to electronic devices, and more particularly to a data card with a universal serial bus (USB) function.

2. Description of Related Art

FIG. 4 is a schematic diagram of an application environment of a data card 10. The data card 10 is connected to a host 20. When the host 20 provides a 3.3V voltage signal to the data card 10, the data card 10 enables a universal serial bus (USB) function of the data card 10. That is, the data card 10 can be used as a USB flash disk.

However, as long as the data card 10 is connected to the host 20, the USB function of the data card 10 is working on even if the data card 10 has not exchanged data with the host 20 for a very long time and enters a sleep mode. Thus, the data card 10 wastes power.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment and functional modules of one exemplary embodiment of a data card in accordance with the present disclosure;

FIG. 2 is a schematic diagram of an application environment and functional modules of another exemplary embodiment of a data card in accordance with the present disclosure;

FIG. 3 is a detailed circuit diagram of one embodiment of a switch of the data card of FIG. 1 in accordance with the present disclosure; and

FIG. 4 is a schematic diagram of an application environment of a data card.

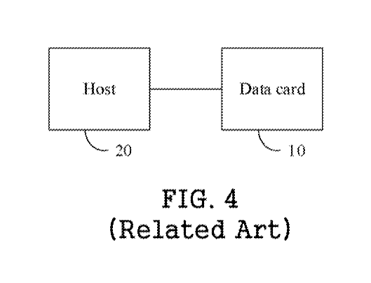

### DETAILED DESCRIPTION

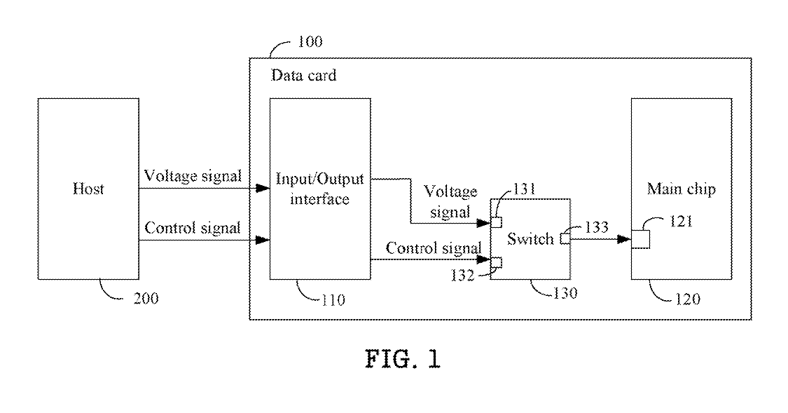

FIG. 1 is a schematic diagram of an application environment and functional modules of one exemplary embodiment of a data card 100 in accordance with the present disclosure. In one embodiment, the data card 100 may be a third generation (3G) data card. The data card 100 is connected to a host 200 to provide a variety of services, such as downloading video, playing music, and surfing the Internet. The host 200 may be a notebook computer, an E-book, or another electronic device with a universal serial bus (USB) function.

In one embodiment, when the host 200 provides a voltage signal (e.g., 3.3V) to the data card 100, the data card 100 enables a USB function of the data card 100. That is, the data card 100 can be used as a USB flash disk for storing data. In other embodiments, the 3.3V voltage signal may be changed to another value such as 5V according to different requirements.

The data card 100 includes an input/output interface 110, a main chip 120, and a switch 130. In one embodiment, the main chip 120 may be an integrated circuit (IC) with a USB function. The main chip 120 includes a USB power pin 121, and operable to enable the USB function of the data card 100 when power is supplied to the USB power pin 121, and disable the USB function when the power is shut down.

The switch 130 includes a voltage input 131, a control input 132, and a voltage output 133. The voltage input 131 and the control input 132 are connected to the input/output interface 110, and the voltage output 133 is connected to the USB power pin 121 of the main chip 120.

The input/output interface 110 is connected to the host 200 to receive a voltage signal and a control signal from the host 200, transmit the voltage signal to the voltage input 131 of the switch 130, and transmit the control signal to the control input 132 of the switch 130. In one example, the input/output interface 110 may be a peripheral component interconnect express (PCIE) interface, which includes 52 pins with 5 pins used for a USB interface. The voltage signal may be set to different voltage values according to different requirements. In one example, the voltage signal may be 3.3V. The control signal includes a first control signal and a second control signal. The first control signal may be a high voltage level signal, and second control signal may be a low voltage level signal. In one example, the high voltage level signal may be a voltage signal greater than 3.3V, and the low voltage level signal may be a voltage signal less than 3.3V.

In one embodiment, the voltage input 131 of the switch 130 receives the voltage signal from the host 200 via the input/output interface 110, and the control input 132 of the switch 130 receives the control signal from the host 200 via the input/output interface 110. When the control signal is the first control signal, the switch 130 connects the voltage input 131 and the voltage output 133, and the voltage signal is transmitted to the USB power pin 121 via the voltage input 131 and the voltage output 133, so that the main chip 120 enables the USB function. When the control signal is the second control signal, the switch 130 disconnects the voltage input 131 from the voltage output 133, and no voltage signal is transmitted to the USB power pin 121, so that the main chip 120 disables the USB function.

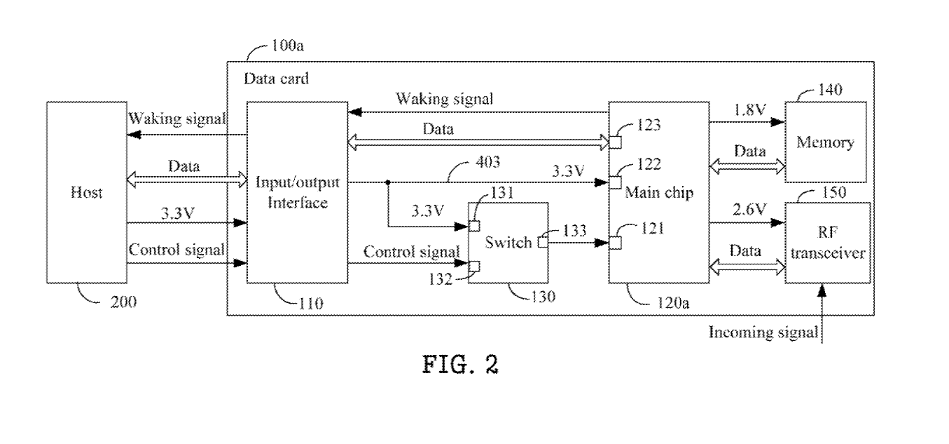

FIG. 2 is a schematic diagram of an application environment and functional modules of another exemplary embodiment of a data card 100a in accordance with the present disclosure. The data card 100a of this embodiment is similar to the data card 100 of FIG. 1, but the data card 100a further includes a memory 140 for storing data and a radio frequency (RF) transceiver 150 for transmitting and receiving RF signals, and the main chip 120a further includes a main power pin 122 and at least one data pin 123. The main chip 120a exchanges data with the memory 140 and the RF transceiver 150.

The main power pin 122 of the main chip 120a is connected to the input/output interface 110. The main chip 120a is further operable to receive the voltage signal from the input/output interface 110 via the main power pin 122, and allocate working voltages for the memory 140 and the RF transceiver 150. In one embodiment, the voltage signal may be 3.3V, the working voltage allocated for the memory 140 may be 1.8V, and the working voltage allocated for the RF transceiver 150 may be 2.6V.

The at least one data pin 123 of the main chip 120a includes two pins and is connected to the input/output interface 110. The at least one data pin 123 is valid when the main chip 120a enables the USB function, and invalid when the main chip 120a disables the USB function. The main chip 120a is further operable to exchange data with the host 200 via the least one data pin 123 and the input/output interface 110 when the main chip 120a enables the USB function.

In one embodiment, the main chip 120a is further operable to enter a sleep mode when the main chip 120a has not exchanged data with the host 200 for a predetermined time period. The predetermined time period may be set to different values according to different requirements. In one example, the predetermined time period may be set to 2 minutes.

The main chip 120a is further operable to receive an incoming signal via the RF transceiver 150, generate a waking signal according to the incoming signal, and transmit the waking signal to the host 200 via the input/output interface 110. In one embodiment, the incoming signal may be an incoming call.

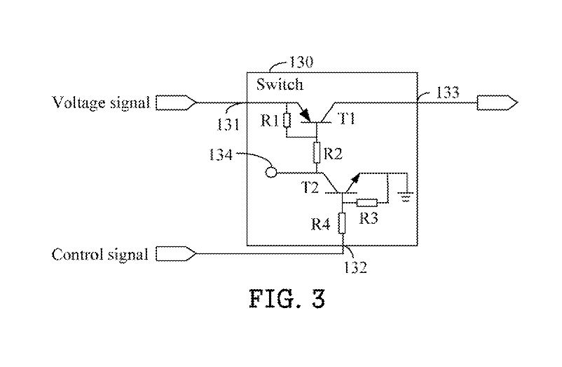

FIG. 3 is a detailed circuit diagram of one embodiment of the switch 130 of the data card 100 of FIG. 1 in accordance with the present disclosure. In one embodiment, the switch 130 is a metal-oxide-semiconductor (MOS) switch, and includes a pnp transistor T1 and a npn transistor T2. An emitter of the pnp transistor T1 acts as the voltage input 131, and operable to receive the voltage signal from the host 200 via the input/output interface 110. A base of the pnp transistor T1 is connected to the emitter of the pnp transistor T1 via a first resistor R1. A connector of the pnp transistor T1 acts as the voltage output 133.

A collector of the npn transistor T2 is connected to the base of the pnp transistor T1 via a second resistor R2, and an emitter of the npn transistor T2 is grounded. A base of the npn transistor T2 is grounded via a third resistor R3, and acts as the control input 132 via a fourth resistor R4, for receiving the control signal.

In one exemplary embodiment, when the control signal is a high voltage level signal, the npn transistor T2 is turned on because the third resistor R3 and the fourth resistor R4 divides a voltage of the control signal. In such a case, a reference terminal 134 is grounded via the npn transistor T2, and accordingly the pnp transistor T1 is also turned on. Thus, the voltage signal is transmitted from the emitter of the pnp transistor T1 to the collector of the pnp transistor T1. In other words, the voltage input 131 connects to the voltage output 133, so the voltage signal is transmitted from the voltage input 131 to the voltage output 133.

In another exemplary embodiment, when the control signal is a low voltage level signal, the npn transistor T2 is cut off because the third resistor R3 and the fourth resistor R4 cannot divide the voltage of the control signal. In such a case, the reference terminal 134 is pulled up by the first resistor R1 and the second resistor R2 because the voltage signal is a high voltage level of 3.3V, and accordingly the pnp transistor T1 is cut off. Thus, the voltage signal cannot be transmitted from the emitter of the pnp transistor T1 to the collector of the pnp transistor T1. In other words, the voltage input 131 disconnects from the voltage output 133, so the voltage signal cannot be transmitted from the voltage input 131 to the voltage output 133.

Thus, when a user does not need the USB function of the data card 100 (100a), the user can control the host 200 to transmit the first control signal to the data card 100 (100a) so as to disable the USB function. When the user needs the USB function of the data card 100 (100a), the user can control the host 200 to transmit the second control signal to the data card 100 (100a) so as to enable the USB function. Therefore, power consumption of the data card 100 (100a) is reduced.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A data card, comprising:
a main chip comprising a universal serial bus (USB) power pin, and operable to enable a USB function of the data card when power is supplied to the USB power pin, and to disable the USB function when the power is shut down;
a switch comprising a voltage input, a control input, and an voltage output connected to the USB power pin; and
an input/output interface connectable to a host to receive a voltage signal and a control signal from the host, transmit the voltage signal to the voltage input, and transmit the control signal to the control input;
wherein when the control signal is a first control signal, the switch connects the voltage input and the voltage output, and the voltage signal is transmitted to the USB power pin via the voltage input and the voltage output, so that the main chip enables the USB function;
wherein when the control signal is a second control signal, the switch disconnects the voltage input from the voltage output, and no voltage signal is transmitted to the USB power pin, so that the main chip disables the USB function.

2. The data card of claim 1, further comprising a memory and a radio frequency (RF) transceiver for transmitting and receiving RF signals, wherein main chip exchanges data with the memory and the RF transceiver.

3. The data card of claim 2, wherein the main chip further comprises a main power pin connected to the input/output interface, and is further operable to receive the voltage signal from the input/output interface via the main power pin, and allocate working voltages for the memory and the RF transceiver.

4. The data card of claim 2, wherein the main chip further comprises at least one data pin connected to the input/output interface, wherein the at least one data pin is valid when the main chip enables the USB function, and invalid when the main chip disables the USB function.

5. The data card of claim 4, wherein the main chip is further operable to exchange data with the host via the least one data pin and the input/output interface when the main chip enables the USB function.

6. The data card of claim 5, wherein the main chip is further operable to enter a sleep mode when the main chip has not exchanged data with the host for a predetermined time period, and operable to receive an incoming signal via the RF transceiver, generate a waking signal according to the incoming signal, and transmit the waking signal to the host via the input/output interface.

7. The data card of claim 1, wherein the first control signal is a high voltage level signal, and the second control signal is a low voltage level signal.

8. The data card of claim 7, wherein the switch comprises:
a pnp transistor with an emitter acting as the voltage input for receiving the voltage signal, a base connected to the emitter via a first resistor, and a connector acting as the voltage output;
an npn transistor with a collector connected to the base of the pnp transistor via a second resistor, an emitter grounded, and a base grounded via a third resistor and acting as the control input via the fourth resistor for receiving the control signal;
wherein when the control signal is a high voltage level signal, the npn transistor and the pnp transistor are turned on, and the voltage signal is transmitted from the emitter of the pnp transistor to the collector of the pnp transistor;
wherein when the control signal is a low voltage level signal, the npn transistor and pnp transistor are cut off, the voltage signal cannot be transmitted from the emitter of the pnp transistor to the collector of the pnp transistor.

9. The data card of claim 1, wherein the input/output interface is a peripheral component interconnect express (PCIE) interface.
